(19) United States
(12) Patent Application Publication
(10) Pub. No.: US 2012/0174370 A1
(43) Pub. Date: Jul. 12, 2012

(54) SYSTEM AND METHOD OF DISASSEMBLING LOCK-DOWN DEVICES

(76) Inventor: John J. Tobin, JR., Wexford, PA (US)

(21) Appl. No.: 13/497,655

(22) PCT Filed: Sep. 23, 2010
(86) PCT No.: PCT/US10/49968

§ 371 Date: Mar. 22, 2012

Related U.S. Application Data
(60) Provisional application No. 61/245,028, filed on Sep. 23, 2009.

(51) Int. Cl. B23P 11/00; B26F 3/00; B25B 27/14

(52) U.S. Cl. 29/426.4; 29/700

(57) ABSTRACT

A method of disassembling a lock-down device in use by a protester may include the steps of applying liquid nitrogen to the lock-down device, wherein the lock-down device includes a connection member for insertion of a protesters arm, wherein the connection member is struck such that it fractures; removing the connection member; and unlocking the protester from the protesters position. A system for disassembling a lock-down device may include a tank for storing the liquid nitrogen; a hose for applying liquid nitrogen; a striking apparatus for fracturing the connection member; an unlocking device for unlocking a protester from the protesters position; and a housing defining a top aperture, wherein the tank, the striking apparatus, and the unlocking device are stored within the housing.

### CROSS REFERENCE TO RELATED APPLICATIONS

The present application claims priority to U.S. Provisional Patent Application No. 61/245,028, filed Sep. 23, 2009, the contents of which are incorporated herein by reference.

### BACKGROUND OF THE INVENTION

1. Field of the Invention

This invention relates to a system and method of disassembling a lock-down device used by protesters for linking their bodies into a chain, and, more particularly, to a system and method of disassembling a lock-down device employing the use of liquid nitrogen.

2. Description of Related Art

Lock-down devices are commonly used by protesters to cause disruption, wherein a group of protesters will in some way link their bodies together forming a chain. Oftentimes, protesters will link themselves to physical landmarks, such as businesses or government buildings. Earlier examples of lock-down devices included handcuffs or chains with padlocks. These types of protests were often quickly and easily broken up by law enforcement personnel wielding a simple set of bolt cutters. As such, the protesters have adapted.

One of the most widely used lock-down devices, sometimes referred to as the “sleeping dragon”, consists of a protestor connection member, such a length of polyvinyl chloride (“PVC”) pipe, and some type of restraint device, such as handcuffs. Protesters will generally insert their arms into the connection member and lock themselves to adjacent protesters by locking their arms in restraint devices, such as handcuffs, chains, or the like. The protesters then link their respective restraint devices to adjacent protesters' restraint devices. Alternatively, protesters lock themselves to an apparatus adapted to receive a restraint device, such as a steel rod or a bolt inserted into the connection member, wherein the protesters then link their restraint device to the steel rod or bolt. Additionally, in place of handcuffs or chains, protesters often use karabiner clips, the loop-shaped hooks having a sprung or screwed gate often used in rock climbing, to lock themselves in position.

Oftentimes, protesters will reinforce the connection member by wrapping it in chicken wire and, further, covering it with tar and/or duct tape. The combination of the connection member, chicken wire, tar, and/or duct tape generally fouls the blades of any cutting tool used to break up the protesters. This makes it very difficult and time consuming to separate and disperse the protesters.

### SUMMARY OF THE INVENTION

A method of disassembling a lock-down device in use by a protester may include the steps of applying liquid nitrogen to the lock-down device, wherein the lock-down device includes a connection member for insertion of a protester's arm and a restraint device for locking the protester in position, wherein the connection member becomes susceptible to fracturing upon application of a striking force after applying liquid nitrogen; striking the connection member such that the connection member fractures; removing the connection member; and unlocking the protester from the protester's position. The connection maybe may be tubular, such as, for example, a pipe. The lock-down device may further include a layer of chicken wire wrapped around the connection member and a layer of tar, wherein the method further includes the steps of applying liquid nitrogen to the lock-down device, wherein the tar becomes susceptible to fracturing upon application of a striking force after applying the liquid nitrogen; striking the tar such that the tar fractures; removing the tar; and removing the chicken wire. Removing the chicken wire may include cutting the chicken wire with a cutting tool. The step of unlocking the protester may include cutting the restraint device with bolt cutters. The restraint device may include a karabiner clip. The method, even further yet, may include the step of sealing off an area of the lock-down device on which to apply the liquid nitrogen prior to applying liquid nitrogen to the lock-down device. This step may include applying a splash guard to the lock-down device. The splash guard may include at least two transportable walls creating a seal around the lock-down device, wherein the protester is protected from exposure to the liquid nitrogen. A sealant may also be applied around a rod inserted into the connection member and to which the restraining device is attached preventing liquid nitrogen from leaking into the connection member exposing the protester to liquid nitrogen.

A system for disassembling a lock-down device may include a tank for storing the liquid nitrogen; a hose for applying liquid nitrogen from the tank to the lock-down device, wherein the lock-down device includes a connection member for insertion of a protester's arm and a restraint device for locking the protester in position, wherein the connection member becomes susceptible to fracturing upon application of a striking force after applying liquid nitrogen; a striking apparatus for fracturing the lock-down device; an unlocking device for unlocking the protester from the lock-down device; and a housing defining an opening, wherein the tank, the striking apparatus, and the unlocking device are stored within the housing, and the hose is attached to the tank and is extendable through the opening The striking apparatus may be a hammer The unlocking device may be a cutting tool, such as bolt cutters. The housing may include a removable top defining a slot through which the hose is extendable. Also, the system may include a hose restraining member positioned on an exterior wall of the housing for restraining the hose when not in use. The system may further include a splash guard having at least two transportable walls creating a seal around the lock-down device, wherein the protester is protected from exposure to the liquid nitrogen. The splash guard may define apertures for receiving the lock-down device. The housing may also include a splash guard storage device, such as a set of hooks adapted for mounting the splash guard on an outside wall of the housing. The housing may be a box for transporting all components of the system. The system may further include a transporting apparatus for the housing, which may be a frame having wheels connected to a bottom portion thereof.

### BRIEF DESCRIPTION OF THE DRAWING(S)

FIG. 1 is a perspective view of a lock-down device disassembling system;

FIG. 2 is a view of a hose nozzle of the system of FIG. 1 in conjunction with a lock-down device;

FIG. 3 is a perspective view of an end of the lock-down device of FIG. 2 immediate prior to use of the system of FIG. 1;

FIGS. 4-6 are schematic representations of a lock-down device;

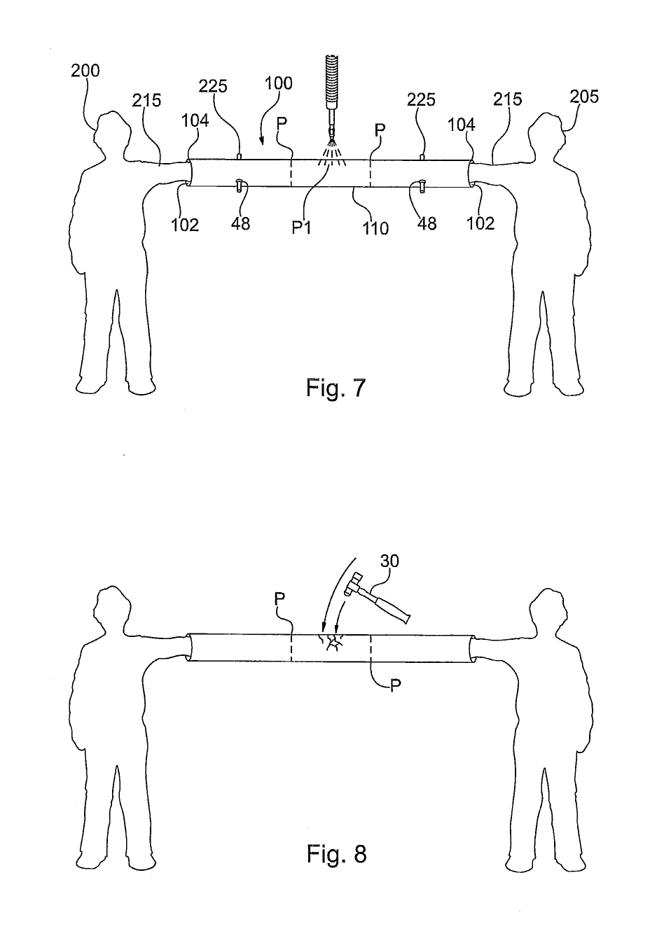

FIGS. 7-10 are schematic representations of the system of FIG. 1 in use;

FIG. 11 is a view of the hose nozzle of FIG. 2 during use of the system of FIG. 1;

FIG. 12 is an enlarged view of a liquid nitrogen supply source according to the system of FIG. 1;

FIG. 13 is an alternative perspective view of the system of FIG. 1;

FIG. 14 is a front view of the embodiment of the system shown in FIG. 13;

FIG. 15 is a front view of the embodiment of the system shown in FIG. 13 prior to use;

FIG. 16 is a rear view of the embodiment of the system shown in FIG. 13; and

FIG. 17 is yet another alternative perspective view of the embodiment of the system shown in FIG. 13.

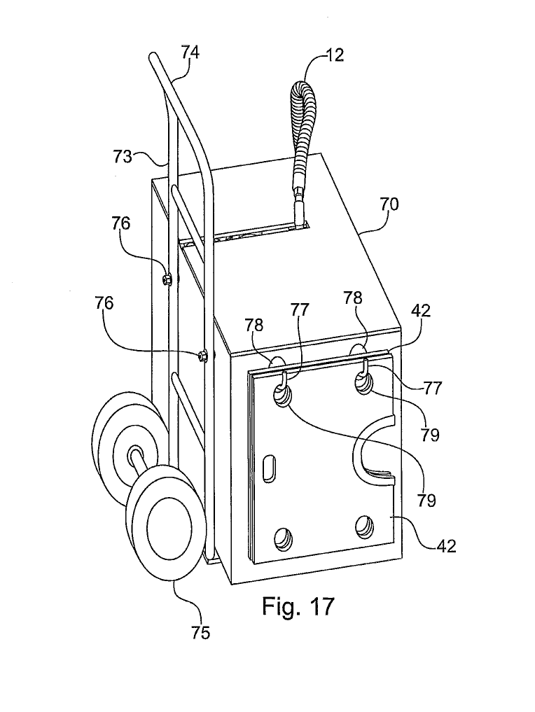

### DESCRIPTION OF THE PREFERRED EMBODIMENTS

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific devices and methods illustrated in the accompanying figures and described herein are simply exemplary and should not be considered as limiting. Additionally, the description is to be read with reference to the noted figures and to the attached color photographs corresponding to the figures.

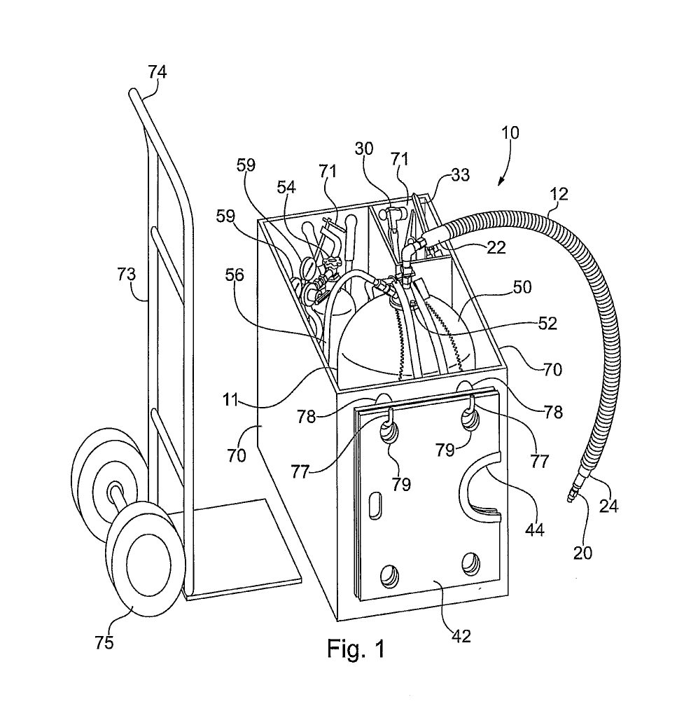

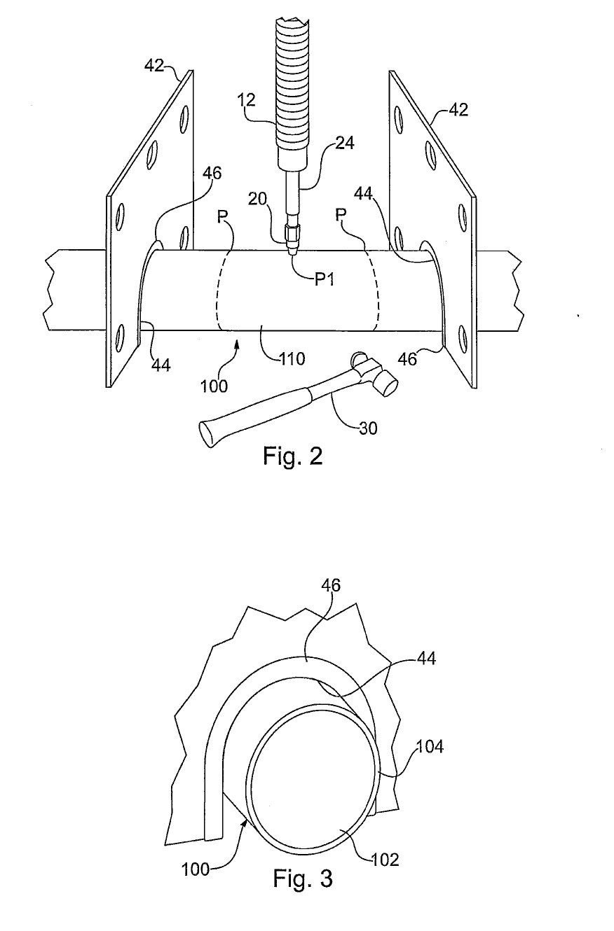

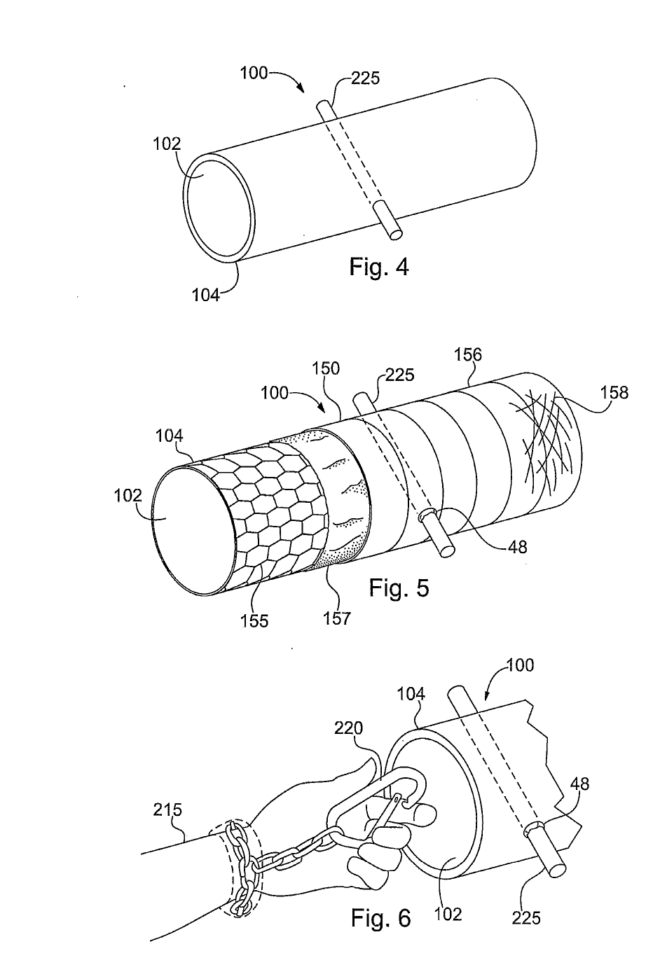

Referring to FIG. 1, a lock-down device disassembling system 10 generally comprises a liquid nitrogen supply source 11 and a hose 12 for applying liquid nitrogen to a lock-down device connected to supply source 11 at a first end 22 of hose 12. Hose 12 will have a nozzle 20 for applying liquid nitrogen at a second end 24, as shown in FIG. 2. Preferably, hose 12 is comprised of steel flex-tube, and most preferably, hose 12 comprises a hose surrounded by corrugated plastic to protect against leakage. Generally, a lock-down device to be disassembled will include a protester connection member 100 having inner chamber 102, as seen in FIG. 3. The connection member 100 may be tubular, such as a length of pipe.

Referring to FIGS. 3 and 6-8, according to the “sleeping dragon” method of lock-down devices, protesters 200, 205 will generally insert their arms into inner chamber 102 of connection member 100 at open end 104. An adjacent protester will insert his or her arms 215 into an opposite open end 104, and the adjacent protesters often link themselves together within connection member 100 by means of a restraint device 220, such as by interlocking sets of handcuffs or chains, or alternatively, linking themselves to a bolt or rod 225 inserted into the connection member 100. Additionally, in practice, the length of connection member 100 used by protesters 200, 205 may approximately measure between 24 and 40 inches. As such, adjacent protesters' 200, 205 arms 215 will not meet, and there will be a strike zone 110 over a length of connection member 100, represented by lines P in FIG. 2, wherein no part of the protesters' 200, 205 arms 215 or hands are physically present.

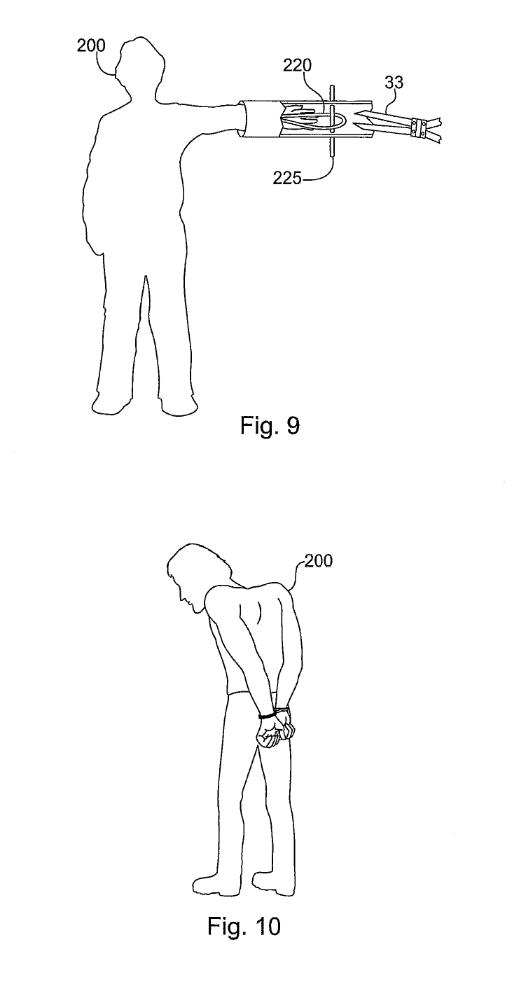

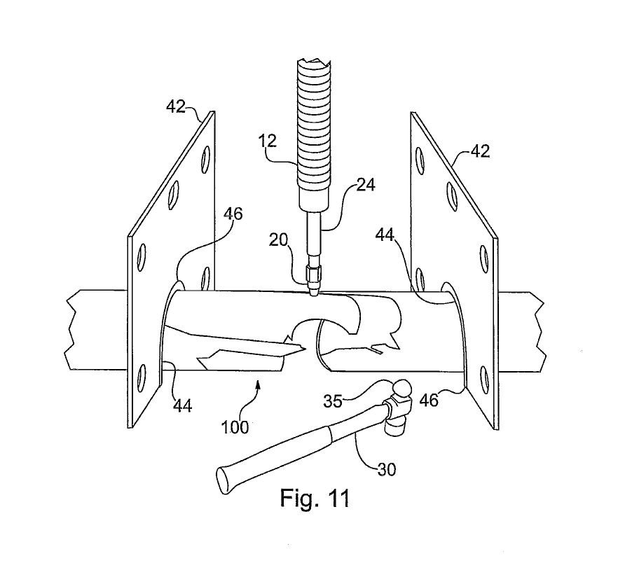

At some point P1, within strike zone 110, nozzle 20 is positioned and liquid nitrogen is applied, as shown in FIG. 7. When applied at point P1 by nozzle 20 of hose 12, the liquid nitrogen will spread over an area of approximately 6 to 8 inches. Referring to FIGS. 8-10, connection member 100 will reach a point, wherein, as a result of continued exposure to the liquid nitrogen, connection member 100 can be struck and will fracture allowing law enforcement personnel to disengage the protesters 200, 205 from connection member 100 and remove them. FIGS. 8, 9, and 11 illustrate a connection member 100 that has been exposed to liquid nitrogen via hose 12 and subsequently struck such that it has been fractured. The amount of exposure to liquid nitrogen required to make connection member 100 susceptible to fracture by striking it will vary with the type of material used in constructing the lock-down assembly. In one embodiment, using 4 feet of 0.5 inch hose connected to a 25 liter tank supplying liquid nitrogen at 3 to 6 psi to 40 gauge pipe, the pipe was found to be susceptible to fracture after exposure to the liquid nitrogen for 45 to 60 seconds.

As shown in FIG. 5, the connection member 100 may be covered by an exterior layer 150 of material in order to make removal and disassembly of the lock-down device as difficult as possible. Oftentimes, as mentioned above, the connection member 100 will be covered with an exterior layer 150, which may include, for example, chicken wire 155, duct tape 156, and/or tar 157. This of course, may require additional time and/or multiple applications of liquid nitrogen in order to remove multiple layers. For example, when disassembling a lock-down device comprising a connection member 100 covered in chicken wire 155, which is then covered in tar 157, a first application of liquid nitrogen may be required to cause the tar 157 to become susceptible to fracture by striking it. After removing the tar 157, the chicken wire 155 may need to be removed by a cutting tool 33, shown in FIGS. 1 and 9, such as bolt cutters. Then, a second application of liquid nitrogen may be required to fracture connection member 100 by striking it. However, it is contemplated, wherein with long enough exposure to liquid nitrogen, connection member 100 and any accompanying tar 157 and/or duct tape 156 may be removed after only one application. In one embodiment of the disclosed method when assembling a lock-down device employing the use of duct tape 156, the duct tape may be scored, such as along score lines 158, prior to applying liquid nitrogen to the lock-down device. By scoring the duct tape 156, the duct tape 156 fractures into smaller, more easily removed pieces after being exposed to the liquid nitrogen.

The step of striking the lock-down device, as shown in FIG. 8, after exposing it to liquid nitrogen, can take a number of forms. For example, the lock-down device can be struck with hammer 30 and may be struck by the hemispherical head 35 of a ball-peen hammer 30, as shown in FIGS. 1, 8, and 11. The ball-peen hammer 30 may be a one pound ball-peen hammer.

Referring to FIGS. 9 and 10, after striking and removing the fractured connection member 100 and any other accompanying materials from exterior layer 150, law enforcement personnel can then unlock and/or disengage the restraint devices 220 used by the protesters 200, 205 to link themselves to adjacent protesters or to the connection member 100 by using an unlocking device, such as the cutting tool 33, wherein the protester 200 can be appropriately removed by law enforcement personnel.

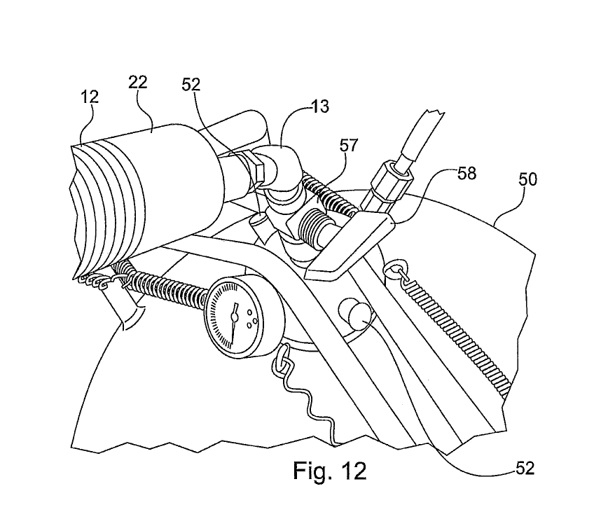

Referring to FIGS. 1-3, 11, and 12, the lock-down device disassembling system 10 may optionally include a set of splash guards 42 having apertures 44 for receiving connection member 100. Apertures 44 may be lined about their perimeters by liners 46, which are adapted to create a seal between splash guards 42 and connection member 100, thereby preventing liquid nitrogen from spreading beyond the area between splash guards 46, eliminating any risk of injury to the protesters 200, 205 as a result of exposure to the liquid nitrogen. Liners 46 may optionally be made from pipe insulation hose. In the event that the protesters 200, 205 have used a restraint device 220 including a steel rod 225 or a bolt inserted into the connection member 100, wherein the protesters 200, 205 have attached a restraint device 220, such as handcuffs, chains or karabiner clips to the steel bolt or rod 225, a sealant 48 may be applied to the entry point of the bolt or rod 225 in connection member 100. This prevents any potential injury to the protesters 200, 205 as a result of liquid nitrogen exposure through the entry point of bolt or rod 225.

As illustrated by the embodiments encompassed by FIGS. 1, 12, and 13, supply source 11 takes the form of a tank 50, which may, for example be 25 liters in volume. Hose 12 is connected to tank 50 via couplings 13. Tank 50 includes pressure release valves 52 to protect tank 50 from rupture resulting from pressure build-up caused by the rapid vaporization of the liquid nitrogen in tank 50. In one particular embodiment, pressure release valves 52 are 10 psi safety release valves. Tank 50 is also accompanied by pressure supply tank 54, as shown in FIG. 1, which is connected to tank 50 via pressure supply hose 56. Tank 50 includes an on/off control 58 for opening valve 57 and supplying liquid nitrogen to hose 12. As shown in FIG. 1, pressure supply tank 54 has two pressure gauges 59. Preferably, pressure supply tank 54 may be a 10 liter pressure supply tank, and pressure supply hose 56 comprises 2 feet of 0.5 inch diameter hose.

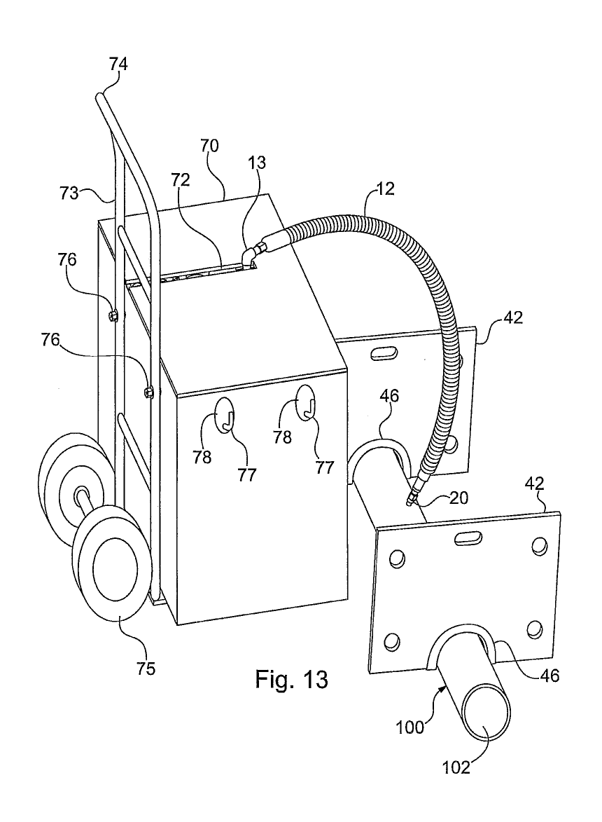

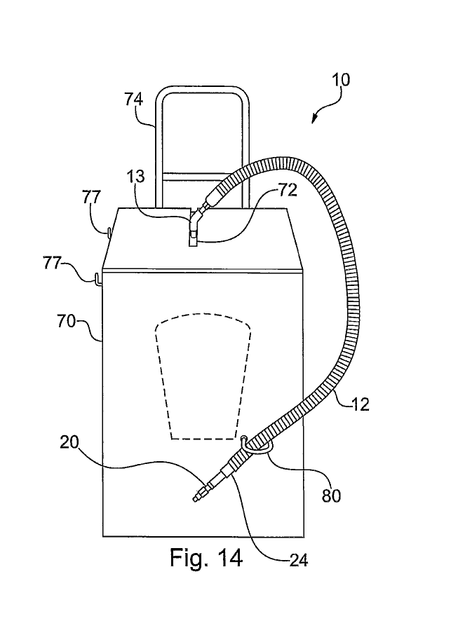

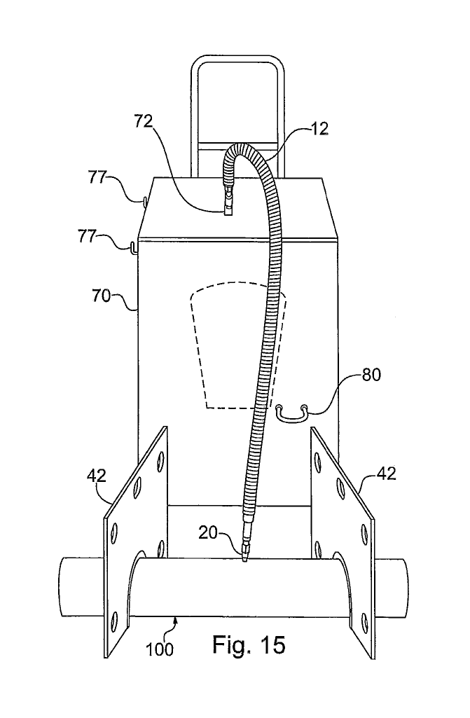

Referring to FIGS. 13-16, in one embodiment, the lock-down device disassembling system 10 may include a fully portable self-contained unit having a housing 70, wherein liquid nitrogen supply source 11 is contained within housing 70. Housing 70 may include a removable top, as best shown in FIG. 13, defining a nitrogen supply hose receiving aperture 72 for receiving hose 12 and couplings 13 for connection to supply source 11. The hose receiving aperture 72, as shown, may be a slot. Housing 70, in the depicted embodiment, may have a height of 28.5 inches, a width of 24 inches, and a depth of 16 inches. In addition to providing portability, housing 70 provides a layer of safety in the event supply source 11 should rupture in some way.

Additionally, as shown in FIG. 1, housing 70 preferably has internal compartments 71 for storage of all supplies that may be required to operate lock-down device disassembling system 10, such as, for example, ball-peen hammer 30. FIG. 1 shows compartments 71 for storage of a set of bolt cutters and a C-clamp. Housing 70 may take the form of a box, but the present invention contemplates any means suitable for transporting a liquid nitrogen supply source and hose for application of liquid nitrogen to a lock-down device.

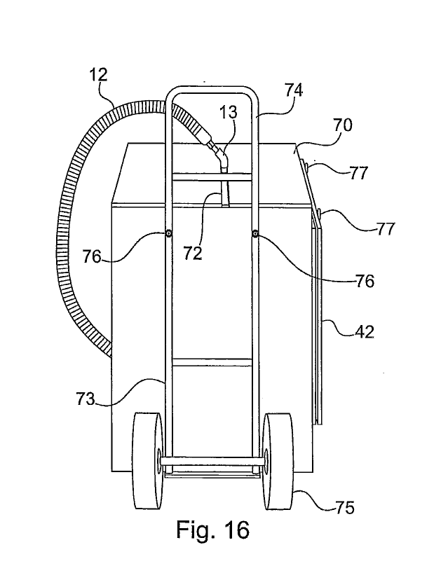

Housing 70 may be attached to a transporting apparatus 74. Transporting apparatus 74 is attached to housing 70 via lock nut and bolt fasteners 76 as illustrated in FIGS. 13 and 16. Transporting apparatus 74 may include a frame 73 having wheels 75 at a bottom portion thereof attached to the back of the housing 70, such as a hand truck; however, any other means suitable for making housing 70 fully portable are contemplated. FIGS. 2, 13, and 15 illustrate housing 70 immediately prior to application of liquid nitrogen to connection member 100.

Lastly, housing 70 may optionally include a splash guard storage device 78 and a hose restraining member 80, as illustrated in FIGS. 13-15. The particular embodiment depicted in FIGS. 13-15 includes a set of hooks 77 capable of receiving storage apertures 79 on splash guards 42. As such, hooks 77 engage splash guards 42 through storage apertures 79; however, any splash guard storage device 78 suitable for transporting splash guards 42 concurrently with housing 70 as a single unit is contemplated. Hooks 77 can be seen clearly in FIGS. 1 and 13-15 without engaging splash guards 42. The hose restraining member 80 provides means of securing the hose 12 to the housing 70 while the lock-down device disassembling system 10 is being transported or in use. As shown, the hose restraining member 80 may include a cantilevered projection defining a slot through which to insert the hose 12, including nozzle 20.

While specific embodiments of a method and system for disassembling a lock-down device were described in the foregoing detailed description, those skilled in the art may make modifications and alterations to these embodiments without departing from the scope and spirit of the invention. Accordingly, the foregoing description is intended to be illustrative rather than restrictive.

The invention claimed is:

1. A method of disassembling a lock-down device in use by a protester, comprising the steps of:
applying liquid nitrogen to the lock-down device, the lock-down device comprising a connection member for insertion of a protester's arm and a restraint device for locking the protester in a protester position, wherein the connection member becomes susceptible to fracturing upon application of a striking force after applying liquid nitrogen;
striking the connection member such that the connection member fractures;
removing the connection member; and
unlocking the protester from the protester position.

2. The method of claim 1, wherein the lock-down device further comprises a layer of chicken wire wrapped around the connection member and a layer of tar, and the method further comprises the steps of:
applying liquid nitrogen to the lock-down device, wherein the tar becomes susceptible to fracturing upon application of a striking force after applying the liquid nitrogen;
striking the tar such that the tar fractures;
removing the tar; and
removing the chicken wire.

3. The method of claim 2, wherein the step of removing the chicken wire comprises cutting the chicken wire with a cutting tool.

4. The method of claim 1, wherein the step of unlocking the protester comprises cutting the restraint device with bolt cutters.

5. The method of claim 4, wherein the restraint device comprises a karabiner clip.

6. The method of claim 1, further comprising the step of sealing off an area of the lock-down device on which to apply the liquid nitrogen prior to applying liquid nitrogen to the lock-down device.

7. The method of claim 6, wherein the step of sealing off the area of the lock-down device on which to apply the liquid nitrogen comprises applying a splash guard to the lock-down device, the splash guard comprising at least two transportable walls, the walls creating a seal around the lock-down device, wherein the protester is protected from exposure to the liquid nitrogen.

8. The method of claim 7, wherein the step of sealing off the area of the lock-down device on which to apply the liquid nitrogen further comprises applying a sealant around a rod inserted into the connection member and to which the restraining device is attached preventing liquid nitrogen from leaking into the connection member exposing the protester to liquid nitrogen.

9. A system for disassembling a lock-down device comprising:
a tank for storing liquid nitrogen;
a hose for applying liquid nitrogen from the tank to the lock-down device;
a striking apparatus for fracturing the lock-down device;
an unlocking device for unlocking the protester from the lock-down device; and
a housing defining an opening, wherein the tank storing the liquid nitrogen, the striking apparatus, and the unlocking device are stored within the housing, and the hose is attached to the tank and is extendable through the opening.

10. The system of claim 9, wherein the housing comprises a removable top, and wherein the opening defined in the housing through which the hose is extendable is a slot defined in the removable top.

11. The system of claim 9, wherein the striking apparatus comprises a hammer.

12. The system of claim 9, further comprising a hose restraining member positioned on an exterior wall of the housing.

13. The system of claim 9, wherein the unlocking device comprises a cutting tool.

14. The system of claim 9, further comprising a splash guard comprising at least two transportable walls creating a seal around the lock-down device, wherein the protester is protected from exposure to the liquid nitrogen.

15. The system of claim 14, wherein the splash guard defines apertures for receiving the lock-down device.

16. The system of claim 15, wherein the housing comprises a splash guard storage device.

17. The system of claim 16, wherein the splash guard storage device comprises a set of hooks adapted for mounting the splash guard on an outside body of self-contained unit.

18. The system of claim 9, wherein the housing comprises a box for transporting all components of the system.

19. The system of claim 9, further comprising a transporting apparatus for the housing.

20. The system of claim 19, wherein the transporting apparatus comprises a frame and wheels connected to a bottom portion of the frame.
